(19) United States
(12) Patent Application Publication
(10) Pub. No.: US 2013/0332890 A1
(43) Pub. Date: Dec. 12, 2013

(54) SYSTEM AND METHOD FOR PROVIDING CONTENT FOR A POINT OF INTEREST

(71) Applicant: Google Inc., Mountain View, CA (US)

(72) Inventors: Haris RAMIC, Santa Clara, CA (US); Su Chuin LEONG, South San Francisco, CA (US); Brian Lawrence ELLIS, Mountain View, CA (US)

(21) Appl. No.: 13/911,018

(22) Filed: Jun. 5, 2013

Related U.S. Application Data
(60) Provisional application No. 61/656,484, filed on Jun. 6, 2012.

(51) Int. Cl. G06F 3/0481

(52) U.S. Cl. CPC G06F 3/04815
USPC 715/852

(57) ABSTRACT

A system and method for providing content for a point of interest are provided. One or more two-dimensional content items are provided for display on a user interface of an electronic device, where each of the one or more two-dimensional content items represents a corresponding point of interest. A user selection of one of the one or more two-dimensional content items is received. A three-dimensional content item corresponding to a point of interest that is represented by the selected two-dimensional content item is provided in response to receiving the user selection of the one of the one or more two-dimensional content items.

### CROSS-REFERENCE TO RELATED APPLICATIONS

The present application claims the benefit of priority under 35 U.S.C. §119 from U.S. Provisional Patent Application Ser. No. 61/656,484 entitled “SYSTEM AND METHOD FOR PROVIDING CONTENT FOR A POINT OF INTEREST” filed on Jun. 6, 2012, the disclosure of which is hereby incorporated by reference in its entirety for all purposes.

### FIELD

The subject technology generally relates to providing content, and in particular, relates to providing content for a point of interest.

### BACKGROUND

A user searching for information for a point of interest often receives an overwhelming amount of information that may or may not relate to the point of interest. The user may be overwhelmed by the amount of received information. Although some of the received information may be pertinent to the user, the user may have a difficult time filtering the received information for information that are relevant to the user. Furthermore, it would be time consuming for the user to traverse through the received information for information that are relevant to the user.

### SUMMARY

The disclosed subject technology relates to a computer-implemented method for providing content for a point of interest. The method includes providing one or more two-dimensional content items for display on a user interface of an electronic device, where each of the one or more two-dimensional content items represents a corresponding point of interest. The method further includes receiving a user selection of one of the one or more two-dimensional content items. The method further includes providing, in response to receiving the user selection of the one of the one or more two-dimensional content items, a three-dimensional content item for display, wherein the three-dimensional content item corresponds to a point of interest that is represented by the selected two-dimensional content item.

The disclosed subject matter further relates to a system for providing content for a point of interest. The system comprises one or more processors, and a machine-readable medium comprising instructions stored therein, which when executed by the processors, cause the processors to perform operations including providing one or more two-dimensional content items for display on a user interface of an electronic device, wherein each of the one or more two-dimensional content items represents a corresponding point of interest. The operations further include receiving a user selection of one of the one or more two-dimensional content items. The operations further include providing, in response to receiving the user selection of the one of the one or more two-dimensional content items, a three-dimensional content item for display, wherein the three-dimensional content item corresponds to a point of interest that is represented by the selected two-dimensional content item. The operations further include receiving a user interaction with respect to the three-dimensional content item. The operations further include adjusting display of the three-dimensional content item based on a type of the user interaction.

The disclosed subject matter further relates to a machine-readable medium comprising instructions stored therein, which when executed by a processor, cause the processor to perform operations including receiving a user-designated geographical location. The operations further include providing one or more two-dimensional content items for display on a user interface of an electronic device, wherein each of the one or more two-dimensional content items represents a corresponding point of interest that is located at or near the received user-designated geographical location. The operations further include receiving a user selection of one of the one or more two-dimensional content items. The operations further include providing, in response to receiving the user selection of the one of the one or more two-dimensional content items, a three-dimensional content item for display, wherein the three-dimensional content item corresponds to a point of interest that is represented by the selected two-dimensional content item. The operations further include receiving a user interaction with respect to the three-dimensional content item. The operations further include adjusting display of the three-dimensional content item based on a type of the user interaction.

The disclosed subject matter further relates to an electronic device, the electronic device including a processor, memory, and display. The processor is configured to provide a user interface depicting a three-dimensional representation of the Earth from a view of a virtual camera. The processor is further configured to change the view of the virtual camera in response to input directed to a first area of the user interface according to a three-dimensional heuristic. The processor is further configured to provide a graphical selection element in a second area of the user interface and respond to input directed to the second area of the user interface according to a two-dimensional heuristic.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for providing content for a point of interest.

FIG. 2 is a block diagram illustrating an example system configured to provide a user electronic device with content associated with a point of interest.

FIG. 3 is a screenshot of an example user interface for providing content for a point of interest.

FIG. 4 is a screenshot of example three-dimensional content item.

FIG. 5 is a flow chart illustrating an example process for providing content associated with a point of interest.

FIG. 6 illustrates an example process for providing content for a point of interest.

FIG. 7 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In accordance with the subject technology, a system and a method for providing content for a point of interest are provided. The point of interest may be located in an area of interest associated with a user. For example, the area of interest associated with the user may be a geographical area viewed by the user in a mapping interface. The area of interest may be specified in different manners. For example, the area of interest can be based on coordinates (e.g., GPS coordinates) provided by a location-aware device of the user. Alternatively, the area of interest can be explicitly specified by the user through a graphical interface of the user's device.

Points of interest may include, among other things, landmarks, tourist attractions, items of interest, historical items, businesses, or other features associated with an area (e.g., geographical area). Points of interest associated with the geographical area of San Francisco, Calif. may include, for example, the Golden Gate Bridge, Alcatraz Island, Fisherman's Wart City Hall, or the City of San Francisco in general. Points of interest may also include personal places of interest (e.g., a place that has value to a user) such as where a person has personal memories. The personal places of interest may be determined based on, for example, a location that a picture associated with the user was taken, a location associated with a post in a social network website, or a location associated with a check-in.

The content may include, among other things, pictures of the point of interest, videos of the point of interest, textual information about the point of interest, or audio related to the point of interest. The content may also include a combination of other content items (e.g., a video tour of a point of interest that includes pictures, videos, text about the point of interest overlaying the pictures or videos, and audio).

The system may provide some of the accessible information that are related to the one or more points of interest to a user interface of an electronic device. In one example, the system provides one or more two-dimensional content items for display on the user interface of the electronic device. One or more applications (e.g., a web browsing application) may provide a user interface for displaying the one or more two-dimensional content items. The one or more two-dimensional content items may be graphical representations of corresponding points of interest (e.g., pictorial previews of the corresponding points of interest). For example, if a point of interest is the Eiffel Tower, then an overhead image of the Eiffel Tower may be a two-dimensional representation of the Eiffel Tower.

The system may provide one or more preselected two-dimensional content items. In one example, one or more preselected two-dimensional content items of globally renowned points of interest (e.g., the Eiffel Tower, the Golden Gate Bridge, etc.) together with a three-dimensional representation of the Earth are provided for as a default display on the user interface.

The user may interact with the user interface in several ways. In one example, the user interface may include an input box that is configured to receive a user-designated geographical location. For example, the user-designated geographical location can correspond to a location explicitly specified by the user, or obtained by a location-aware device of the user (e.g., a GPS location). Where the user has designated a geographical location, the one or more two-dimensional content items may represent one or more corresponding points of interest that are located at or near the received user-designated geographical location. Alternatively, where the user had previously designated a geographical location, the one or more two-dimensional content items may represent one or more corresponding points of interest that are located at or near the prior use designated geographical location.

The system may receive a user selection of one of the one or more two-dimensional content items. Upon receipt of a user section of the one of the one or more two-dimensional content items, a three-dimensional content item corresponding to a point of interest that is represented by the selected two-dimensional content is provided. In one example, the three-dimensional content item is a fly-through sequence from one location on a three-dimensional interactive map to the point of interest. The three-dimensional interactive map may provide one or more views (e.g., overhead view, satellite view, traffic view, etc.). Additional examples of a three-dimensional content items include, but are not limited to virtual tours of the point of interest, images corresponding to the point of interest, etc. The three-dimensional content item may also contain additional content (e.g., text, audio, pictorial, video, etc.) that are incorporated to provide a detailed and user friendly overview of the point of interest.

The user may engage in several types of interactions with the provided three-dimensional content item. In one example, if the three-dimensional content item is a fly-through sequence from one location on a three-dimensional interactive map to the point of interest, a scrolling type action modifies the display size of the provided three-dimensional content item with respect to the user interface. If the three-dimensional content item is displayed on an electronic device that supports a pinch-type action (e.g., a smartphone device, a tablet computer, etc.), the display size of the provided three-dimensional content item may be modified in response to a user pinch action.

A user interaction with respect to the three-dimensional content item may also cause the one or more two-dimensional content items to be replaced with new two-dimensional content items. In one example, the three-dimensional content item is a three-dimensional interactive map centered at the Eiffel Tower. If a subsequent user interaction with the three-dimensional interactive map causes the interactive map to shift its center to a location at or near the Golden Gate Bridge, and any two-dimensional content item that represents a point of interest at or near the Eiffel Tower is replaced with a two-dimensional content item that represents a point of interest at or near the Golden Gate Bridge.

By providing content related to a point of interest located in an area of interest for a user (e.g., the geographical area in a mapping interface being viewed by the user), the system may enable the user to quickly learn about the one or more points of interest in the area of interest. Furthermore, instead of the user being exposed to many content items that may be of varied quality, the system may provide the user with content that best describes the point of interest. For example, the system may select the most popular content items associated with a point of interest or generate content that includes the most popular content items associated with the point of interest.

In accordance with the subject technology, an electronic device that includes a processor, memory, and display is also provided. The processor of the electronic device is configured to provide a user interface depicting a three-dimensional representation of the Earth from a view of a virtual camera. The processor of the electronic device is further configured to change the view of the virtual camera in response to input directed to a first area of the user interface according to a three-dimensional heuristic. In one example, the three-dimensional heuristic maps one or more input gestures to at least one of the following commands: pan the virtual camera, zoom the virtual camera, rotate the virtual camera, tilt the virtual camera, or rotate the three-dimensional representation of the Earth. A first area of the user interface may depict the three-dimensional representation of the Earth and the second area of the user interface comprises an overlay within the first area of the user interface.

The processor of the electronic device is further configured to provide a graphical selection element in a second area of the user interface and respond to input directed to the second area of the user interface according to a two-dimensional heuristic. The graphical selection element may include a filmstrip having a plurality of individual frames, each frame corresponding to an item of content associated with geographic areas shown in the view of the virtual camera. Furthermore, at least one graphical selection element may correspond to a tour of a geographic area and the processor, in response to selection of the tour, carries out an action to provide a tour and provides the tour by moving the camera within the three-dimensional representation of the Earth. In one example, the two-dimensional heuristic maps one or more input gestures to at least one of the following commands: carry out an action associated with the graphical selection element, display a different graphical selection element. In one example one of the one or more input gestures is a swipe gesture and the two-dimensional heuristic maps the swipe gesture to the command to display a different graphical selection element.

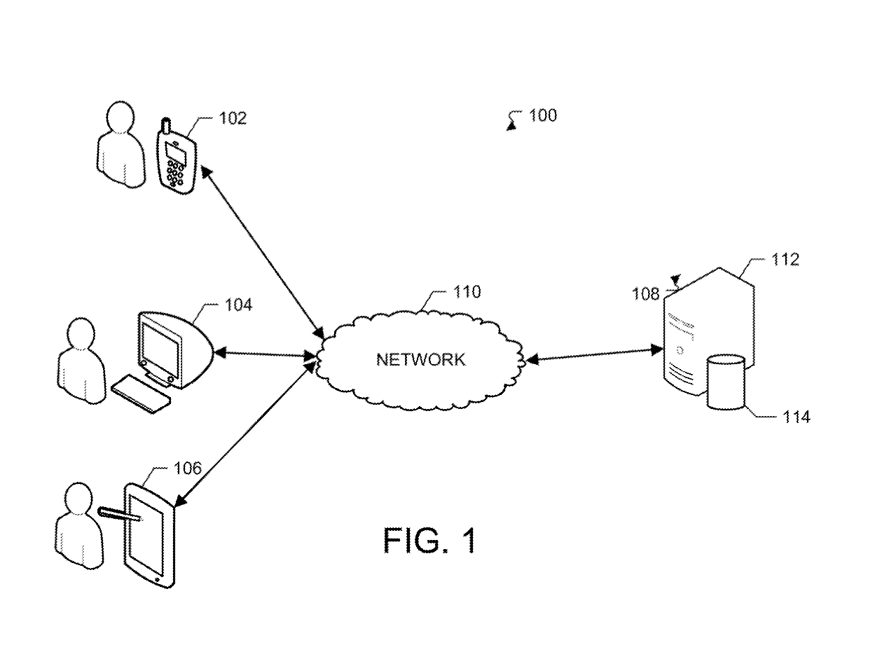

FIG. 1 illustrates an example distributed network environment for providing content for a point of interest. A network environment 100 includes a number of electronic devices 102, 104, and 106 communicably connected to a server 108 by a network 110. Server 108 includes a processing device 112 and a data store 114. Processing device 112 executes computer instructions stored in data store 114, for example, to provide content for a point of interest.

In some example aspects, each of the electronic devices 102, 104, and 106 may include any machine with hardware and software to access one or more content and to provide the one or more content for display on the respective electronic device, 102, 104, or 106. Electronic devices 102, 104, and 106 can be mobile devices (e.g., smartphones, tablet computers, PDAs, and laptop computers), portable media players, desktop computers, television systems, or other computing devices. In the example of FIG. 1, electronic device 102 is depicted as a smartphone, electronic device 104 is depicted as a desktop computer, and electronic device 106 is depicted as a tablet computer.

Electronic device 102, 104, or 106 provides one or more two-dimensional content items for display on a user interface of an electronic device. The one or more two-dimensional content items may be selected based on the type of the electronic device. One or more applications (e.g., a web application) running on electronic device 102, 104, or 106 may provide a user interface for providing the one or more two-dimensional content items (e.g., one or more pictorial previews of corresponding points of interest) for display. The user interface may include one or more user selectable controls (e.g., user input boxes) that are configured to receive a user-designated geographical location. Upon receipt of a user-designated geographical location, the electronic device 102, 104, or 106 may provide the user-designated geographical location to server 108 via the network 110.

The one or more two-dimensional content items represent corresponding points of interest. In one example, the one or more two-dimensional content items represent one or more preselected points of interest that are of global interest. In another example, where the electronic device 102, 104, or 106 received a user-designated geographical location, the one or more two-dimensional content items represent one or more corresponding points of interest that are located at or near the received user-designated geographical location. In another example, the one or more two-dimensional content items represent one or more corresponding points of interest that are located at or near a prior user-designated geographical location.

Electronic device 102, 104, or 106 receives a user selection of the one or more two-dimensional content items. The user selection is then transmitted to the server 108 via the network 110.

Server 108 may be any system or device having a processor, memory, and communications capability for providing messaging recommendations for electronic messaging. Server 108 may be a single computing device such as a computer server. Server 108 may also represent more than one computing device working together to perform the actions of a server computer.

Server 108 includes a processing device 112 and a data store 114. Processing device 112 executes computer instructions stored in a computer-readable medium, for example, to provide content for a point of interest to electronic device 102, 104, or 106. Data store 114, contains the content for a point of interest as well as other content which may be transmitted to the electronic device 102, 104, or 106.

Electronic device 102, 104, or 106 receives a three-dimensional content item corresponding to a point of interest that is represented by the selected two-dimensional content item in response to receiving the user selection of the one or more two-dimensional content items. In one example, the three-dimensional content item is a fly-through sequence from a first location on a three-dimensional interactive map to the point of interest that is represented by the selected two-dimensional pictorial preview. In another example, the three-dimensional content item is a video feed corresponding to the point of interest that is represented by the selected two-dimensional pictorial preview. In another example, the three-dimensional content item is a three-dimensional representation of the Earth.

Electronic device 102, 104, or 106 may receive a user interaction with respect to the three-dimensional content item and adjust the display of the three-dimensional content item based on the type of the user interaction. In one example, the user interaction is a pinch-type user action, and the three-dimensional content item is adjusted to zoom in or zoom out in response to the pinch-type user action. In another example, the user interaction is a tilt-type interaction about an axis, and the three-dimensional content item is adjusted to tilt about the axis in response to the tilt-type user action.

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

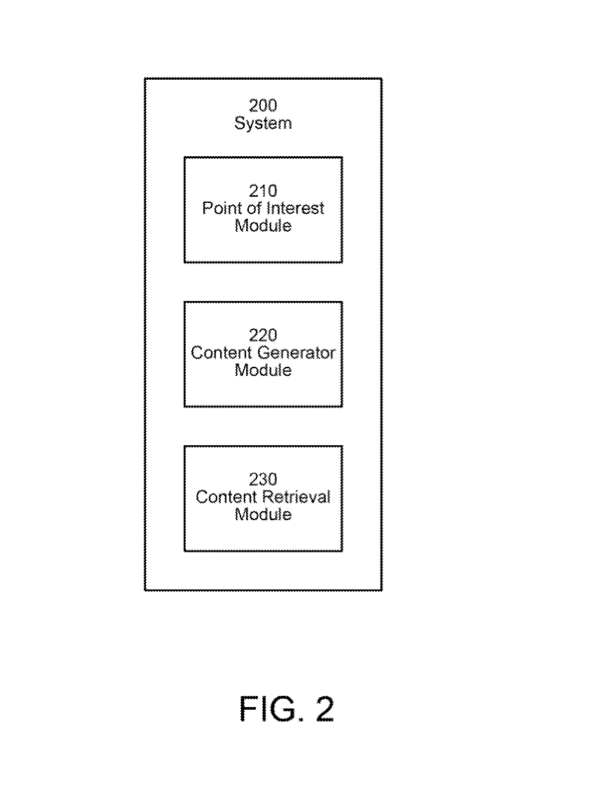

FIG. 2 is a block diagram illustrating an example system 200 configured to provide a user with content associated with a point of interest, in accordance with various aspects of the subject technology. The system 200 may include a point of interest module 210, a content generator module 220, and a content retrieval module 230. In other aspects, however, the system 200 may include additional components, fewer components, or alternative components. The system 200 may also be implemented one or more computing machines (e.g., one or more servers or server clusters).

The point of interest module 210 may be configured to store information about points of interest known to the system 200. For example, point of interest module 210 may store a record for each point of interest that includes a point of interest name, a point of interest address, a point of interest location (e.g., location coordinates), key words or categories associated with the point of interest, or any other information associated with the point of interest.

The content generator module 220 may configured to access one or more sources (e.g., data repositories such as a database) of content items associated with a point of interest. In one example, one or more of the accessible content items are two-dimensional content items. In another example, one or more of the accessible content items are three-dimensional content items. Each content item may be a picture, a video, text, audio, or any other form of data associated with a point of interest. Content items may also be associated with one or more perspectives, which may include for example, a 2-dimensional view, a 3-dimensional view, and a camera view. The camera views may include information such as a camera angle, camera location coordinates, and a camera altitude.

The content generator module 220 may select certain content items and use the selected content items to generate content associated with a point of interest. For example, in some variations, the content may be a be a “virtual tour” of a point of interest that contains content items and is designed to provide a user with information about the point of interest.

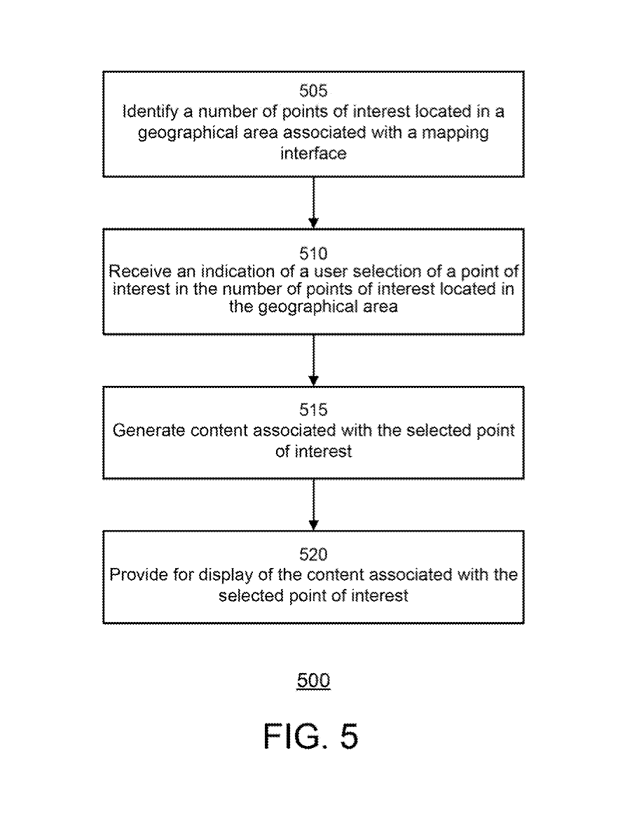

According to aspects of the subject technology, a content item may be selected by the content generator module 220 based on a measure of how useful the content item would be to a user. For example, the content generator module 220 may calculate a score for each content item based on various factors or signals (e.g., the number of times a content item was accessed or viewed, a rating for the content item, the quality of a item, etc.). The content generator module 220 may then select content items to include in the content associated with the point of interest based on the scores of the content items. Further details regarding the scoring of the content items is discussed further below with respect to, for example, FIG. 5.

The content retrieval module 230 may be configured to identify a number of points of interest located in an area of interest for a user (e.g., the geographical area in a mapping interface being viewed by the user) and enable the user to choose one or more of the points of interest. In response to the user selection of a point of interest, the content retrieval module 230 may retrieve the content associated with the point of interest and provide the content to the user's client device so that the user may access the content (e.g., the user may view the content in a user interface displayed on the client device). In one example, the retrieved content is a two-dimensional content item. In another example, the retrieved content is a three-dimensional content item.

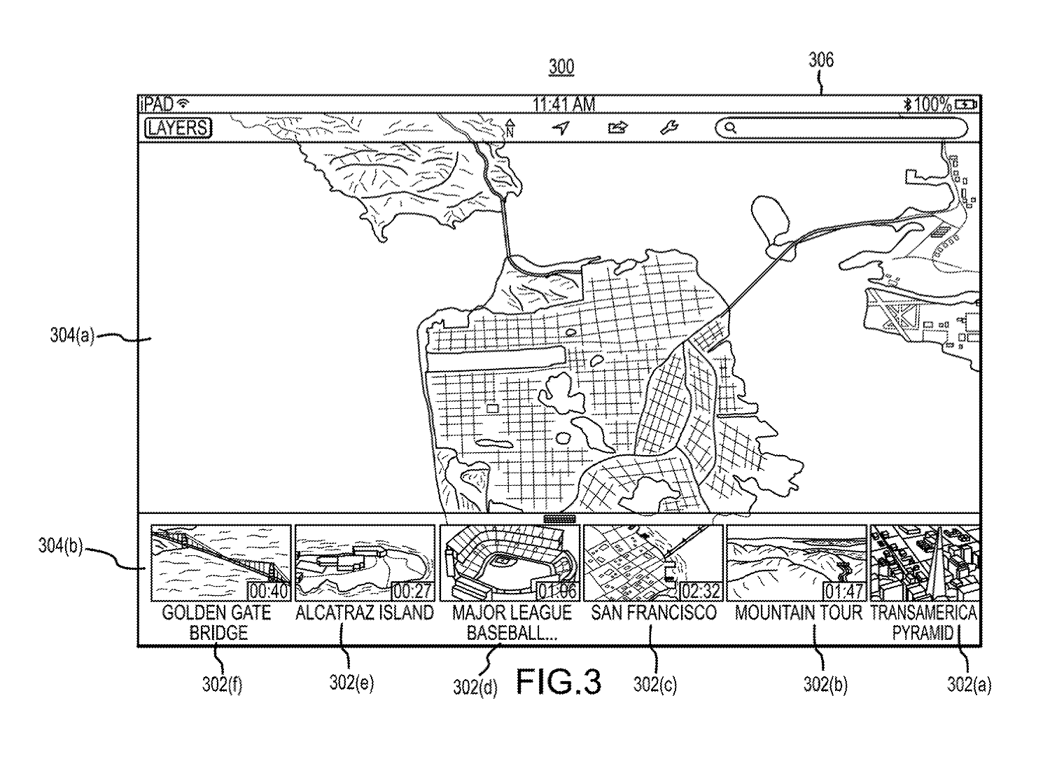

FIG. 3 is a screenshot of an example user interface for providing content for a point of interest. In the example of FIG. 3, a user interface 300 provides six two-dimensional content items 302(a)-302(f). Each of the six two-dimensional content items represents a corresponding point of interest. As seen in FIG. 3, two-dimensional content item 302(a) is a pictorial preview of a point of interest for Transamerica Pyramid, two-dimensional content item 302(b) is a pictorial preview of a point of interest for Mountain Tour, two-dimensional content item 302(c) is a pictorial preview of a point of interest for San Francisco, two-dimensional content item 302(d) is a pictorial preview of a point of interest for Major League Baseball, two-dimensional content item 302(e) is a point of interest for Alcatraz Island, and two-dimensional content item 302(f) is a point of interest for Golden Gate Bridge.

FIG. 304(a) is an area of the user interface that displays a three dimensional content item. FIG. 304(b) is an area of the user interface that displays one or more two-dimensional content items 302(a)-302(f). As seen in FIG. 3, two dimensional content items 302(a)-302(f) are each one of a plurality of selection items arranged in a filmstrip. In this example, the filmstrip is an overlay in area 304(b) of the user interface below area 304(a). However, the filmstrip size and shape are for purposes of example only, and the selection items could be located at different locations relative to area 304(a).

The user may select any of the provided two-dimensional content items 302(a)-302(f). In one example, the user may select any of the provided two-dimensional content items 302(a)-302(f) via a user action (e.g., a tap gesture, a hover gesture, a click gesture, etc.) with respect to an area of the interface that is displaying the respective two-dimensional content item. In another example, a two dimensional heuristic can be used for input directed to the area of the user interface that includes the filmstrip of two-dimensional content items 302(a)-302(f). For example, the two dimensional heuristic can map a swipe gesture in area 304(b) to correspond to a request to update the filmstrip. In one example, if there is more than six relevant points of interest pertinent to the San Francisco bay area, and the user interface of FIG. 3 can only provide six relevant points of interest for display at time, the user can view additional points of interest pertinent of the San Francisco bay area by swiping across area 304(b) of the user interface. In response to the user swipe gesture across the area 304(b), the electronic device can populate the filmstrip with different two-dimensional content items for selection. Additional user gestures directed towards area 304(b) can be mapped accordingly to correspond to additional commands (e.g., to rearrange one or more content items, rotate one or more content items, move one or more content items, etc.). It will be understood that any number of type of input gestures can be mapped to corresponding commands in various embodiments and the commands and gestures discussed herein are for purposes of example only.

A three-dimensional content item corresponding to a point of interest that is represented by the selected two-dimensional content item is provided in response to a user selection of any of the two-dimensional content items 302(a)-302(f). As seen in FIG. 3, a three-dimensional content item for San Francisco is provided in area 304(a). For example, as seen in FIG. 3A, a virtual camera is pointed downward towards a model of the Earth at coordinates that correspond to the city of San Francisco and surrounding area. In some implementations, the view shown in area 304(a) can be changed in response to one or more gestures directed towards area 304(a). In particular, a three-dimensional heuristic (or a set of heuristics) may map different input gestures to commands defined with respect to a three-dimensional environment. e.g., commands to move the virtual camera and/or the model of the environment or items within. For example, a two-finger drag gesture can be mapped to a command to tilt the virtual camera to a different angle. The tilting of the virtual camera may reveal different and/or additional content not previously visible from a downward view. A pinch gesture can be mapped as a command to zoom the camera towards or away from a point in the three-dimensional environment. Another gesture can be mapped to a command to rotate the virtual camera. A type of gesture can be mapped to two or more commands. For example, a swipe gesture directed towards the film strip area 304(b) changes two-dimensional content items shown in the film strip. However, a swipe gesture directed towards an area of the three-dimensional environment tilts the virtual camera. It will be understood that any number of type of input gestures can be mapped to corresponding commands in various embodiments and the commands and gestures discussed herein are for purposes of example only.

The three-dimensional content item for San Francisco may also include a fly-through sequence from a first location on a three-dimensional interactive map to San Francisco. The three-dimensional content item for San Francisco may also include a video feed of San Francisco. Additional examples of a three-dimensional content item include, but are not limited to, virtual tours of San Francisco, images San Francisco, etc. The three-dimensional virtual content of San Francisco may also contain additional content (e.g. text, audio, pictorial, video, etc.) that are incorporated to provide a detailed and user friendly overview of San Francisco.

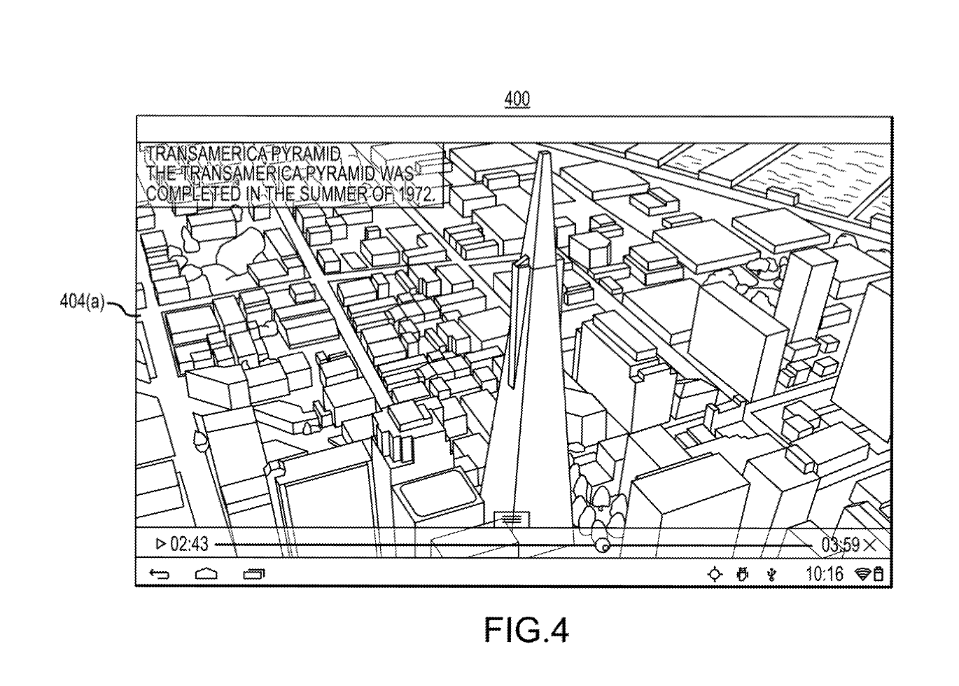

FIG. 4 is a screenshot of example three-dimensional content item. As seen in FIG. 4, a three-dimensional content item of Transamerica Pyramid 304(a) is provided. As seen in FIG. 4, the three-dimensional content item for Transamerica Pyramid includes a fly-through sequence from a first location on a three-dimensional interactive map to the Transamerica Pyramid. The three-dimensional content item for Transamerica Pyramid may also include a video feed of the Transamerica Pyramid. Additional examples of a three-dimensional content item include, but are not limited to virtual tours of the Transamerica Pyramid, images the Transamerica Pyramid, etc. The three-dimensional virtual content of the Transamerica Pyramid may also contain additional content (e.g., text, audio, pictorial, video, etc.) that are incorporated to provide a detailed and user friendly overview of the Transamerica Pyramid.

FIG. 5 is a flow chart illustrating an example process 500 for providing content associated with a point of interest, in accordance with various aspects of the subject technology. Although the operations in process 500 are shown in a particular order, certain operations may be performed in different orders or at the same time. For example, certain steps, or portions of certain steps may occur offline. In addition, although the process steps of FIG. 5 are described with reference to FIG. 2, the steps are not limited to being performed by the system of FIG. 2.

At step 505, the content retrieval module 230 may identify a number of points of interest located in a geographical area associated with a mapping interface. For example, if the user is viewing a geographical area in a mapping interface (e.g., user interface 300 in FIG. 3) on an electronic device, the content retrieval module 230 may identify all points of interest located in the geographical area.

An option to view content for each of the identified points of interest may then be presented to the user. However, in some cases, there may be more points of interest located in a geographical area than can be effectively shown to a user. Accordingly, according to one aspect of the subject technology, the content retrieval module 230 may select a subset of the points of interest in the geographical area and only options to view content for the subset of points of interest will may be presented to the user.

The content retrieval module 230 may select the subset of the points of interest based on, for example, a point of interest ranking score and/or user information. According to one aspect, a point of interest ranking score is a value assigned to a point of interest by the point of interest module 210. The point of interest module 210 may calculate the ranking score for a point of interest using various factors and signals such as a number of content items associated with the point of interest, a number of times a point of interest is visited by all users, a number of times a point of interest is searched for in a search engine, a number of times web pages containing references to a point of interest is accessed, etc. In some aspects, the ranking of the points of interest may occur, at least in part, offline (e.g., prior to a request from a client device associated with the user, the ranking score for a point of interest may be stored in the record for the point of interest for later retrieval).

The content retrieval module 230 may also select the subset of the points of interest based on user information such as the user's current location, a user's favorite locations (points of interest visited by the user often, points of interest discussed on a social networking website associated with the user, or points of interest related to web pages visited by the user), user preferences (e.g., a user prefers points of interest related to nature over urban points of interests).

According to another aspect, one or more of the points of interest in the subset may be set by an administrator. For example, if an event (e.g., the Olympics) are being held in the geographic area, an administrator may set a point of interest to be the Olympic village.

The content retrieval module 230 may receive a user selection of a point of interest of a point of interest at step 510. In response to the user selection, the content retrieval module 230 may retrieve content associated with the selected point of interest.

In some cases, there may be more than one choice in content associated with the selected point of interest. Accordingly, the user may be presented with an option to select between the choices in content or the content retrieval module 230 may automatically choose one of the choices in content based on, for example, the user information as discussed above.

The choice in content may also be chosen based on device information associated with the electronic device used by the user. For example, the electronic device may have a small screen, limited computing power, or limited bandwidth (e.g., a smart phone). Accordingly, a content choice that is better suited for the electronic device may be chosen to be provided to the user. The better suited content choice for a smart phone with a small screen and limited computing power may be, for example, content with larger text or with less video that requires more bandwidth and processing power.

According to one aspect, the retrieved content may be generated before hand (e.g., before step 505 and/or 510) by the content generator module 220. According to another aspect, the retrieved content may be generated on-the-fly. For example, at step 515, in response to the user selection, the content generator module 220 may generate content associated with the selected point of interest. The generated content may be static content or dynamic content.

At step 520, the content associated with the selected point of interest may be provided to a user. For example, the content may be transmitted to an electronic device associated with the user, where it may be displayed to the user.

According to various aspects of the subject technology, before generating content using content items associated with a selected point of interest, the content generator module 220 may need to identify which points of interest a content item is associated with. For example, the content generator module 220 may be configured to access one or more sources (e.g., data repositories such as a database) of content items and determine whether each of the content items is associated with a point of interest using one or more methods which may include manual determinations (e.g., inspection by an administrator) and/or automatic determinations.

For example, the content generator module 220 may compare location information associated with the content item (e.g., location coordinates of a photograph) with the location of a point of interest. If the location information associated with the content item is within a threshold distance of the location of the point of interest, the content item may be associated with the point of interest. In another aspect, content items may already be an individual may take a photograph or video, upload it to the system 200, and specifically indicate that the photograph or video is associated with a particular point of interest.

According to another aspect, the content generator module 220 may also determine whether a content item is associated with a point of interest based on similarities with other content items known to be associated with a point of interest. For example, a photograph may include image elements (e.g., buildings, landmarks, etc.) that are also included in other photograph associated with a particular point of interest and the photograph may be associated with location coordinates within a threshold distance of the location coordinates of the other photographs.

For each point of interest, the content generator module 220 may also be configured to calculate a score for each of the content items associated with the point of interest. The score may be based on various signals such as the number of times the content item has been accessed (e.g., viewed) or ratings for the content item given by other users. The score for a content item may also be calculated based on various characteristics of the content item (e.g., a number of pixels for a photograph, a bit-rate for audio or video content, etc.).

According to one aspect of the subject technology, a content item that is a picture or video may also be given a score based on a view of the point of interest in the picture or video. For example, the content generator module 220 may identify an “optimal view” of a particular point of interest based on location information (e.g., location coordinates and altitude) of one or more pictures or videos that have been accessed the largest number of times.

For example, the content generator module 220 may determine optimal location coordinates and an optimal altitude by averaging the location coordinates and altitude of the one or more pictures or videos that have been accessed the most. The score for a content item (e.g., a picture or video) may then be calculated based on, among other things, how close the location coordinates associated with the content item is to the optimal location coordinates and how close the altitude associated with the content item is to the optimal altitude.

According to some aspects of the subject technology, the content generator module 220 may also be configured to generate content that includes one or more of the content items associated with a point of interest. For example, the content generator module 220 may select one or more of the content items based on the scores for the content items. In one aspect, the content items with the highest scores may be selected.

According to one aspect, the content may be a combination of content items. For example, several content items in the form of images or videos may be selected and combined to form content associated with a point of interest. content items of different categories may also be selected and combined. For example, content items in the form of text may be selected and combined with one or more pictures or videos such that the text appears on the pictures or videos (e.g., as a textual overlay). Alternatively, or in addition, content items in the form of audio files (e.g. an audio file with a narrator talking about a point of interest or a sound track) may be combined with one or more images, videos, or text.

In one aspect, the content (e.g., a “virtual tour”) may include one or more fly-through views for an associated point of interest. For example, the content may include a video content item that shows a larger geographic area zooming-in to a smaller geographic area that includes the point of interest. Alternatively, the content may include a video content item that shows a view of traveling from one geographic area (which may include another point of interest) to a different geographic area containing a selected point of interest.

According to another aspect, when a fly-through views (e.g., a video content item that shows the traveling to the geographic area of the selected point of interest) arrives at the geographical area of the selected point of interest, the fly-through views may include views of the area surrounding the point of interest (e.g., the view may circle the point of interest) and end up with a view that corresponds to the “optimal view” of the point of interest.

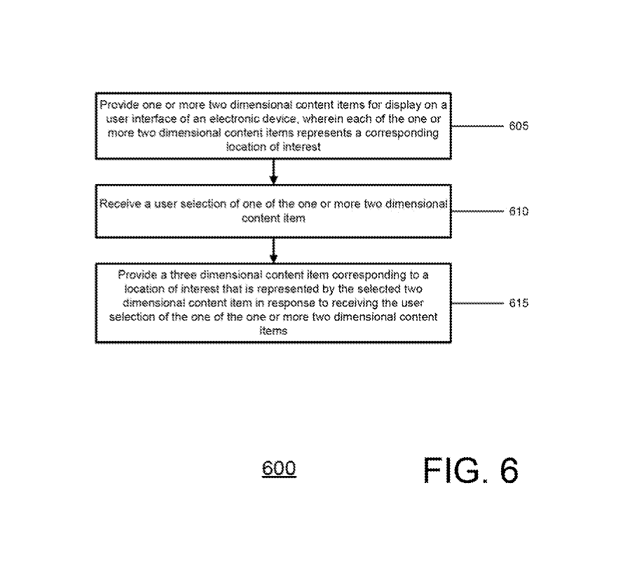

FIG. 6 illustrates an example process for providing content for a point of interest. Although the operations in process 600 are shown in a particular order, certain operations may be performed in different orders or at the same time.

In step 605, one or more two-dimensional content items are provided for display on a user interface, where each of the one or more two-dimensional content items represents a corresponding point of interest. In one example, the one or more two-dimensional content items may be provided by system 200. Furthermore, the one or more two-dimensional content items may be pictorial previews of corresponding points of interest. One or more applications (e.g., a web application) running on an electronic device 102, 104, or 106 may provide a user interface for displaying the one or more two-dimensional content items. Although the process steps of FIG. 6 are described with reference to FIGS. 1, 2, and 5, the steps are not limited to being performed by such systems.

The user interface may include one or more user selectable controls (e.g., a user input box) that is configured to receive a user-designated geographical location. Where the user designates a geographical location, the one or more two-dimensional content items represent one or more corresponding points of interest that are located at or near the received user-designated geographical location. Where the user designates a new geographical location, one or more two-dimensional content items that represent one or more corresponding points of interest that are located at or near the newly received user-designated geographical location are provided. In one example, one or more two-dimensional content items corresponding to points of interest at or near Paris are initially provided. However, upon a subsequent user input of a geographical location at or near San Francisco, the one or more two-dimensional content items corresponding to points of interest in Paris are replaced with one or more two-dimensional content items corresponding to points of interest at or near San Francisco.

In another example, the one or more two-dimensional content items represent preselected points of interest that are of global interest. In a case where the user interface is first displayed to the user, preselected points of interest may be provided to the user. However, if the user interface has previously been displayed to the user, the most recently displayed two-dimensional content item may be provided for display on the user interface. For example, the one or more two-dimensional content items may represent one or more corresponding points of interest that are located at or near a prior user-designated geographical location.

In step 610, a user selection of one of the one or more two-dimensional content items is received. In one example, the process described in FIG. 5 is performed to provide a three-dimensional content item corresponding to the point of interest that is represented by the selected two-dimensional content item.

In step 615, the three-dimensional content item corresponding to a point of interest that is represented by the selected two-dimensional content item is provided. The three-dimensional content item may include a fly-through sequence from a first location on a three-dimensional interactive map to the point of interest that is represented by the selected two-dimensional content item. For example, a fly-through sequence from a preselected location on a three-dimensional interactive map to San Francisco is provided in FIG. 3 in response to a user selection of the pictorial preview for San Francisco 302(c). The three-dimensional content item may also include a three-dimensional video feed corresponding to the point of interest that is represented by the selected dimensional pictorial view. Furthermore, the three-dimensional content item may be a three-dimensional representation of the Earth.

The user may engage in one or more types of interactions with the three-dimensional content, and display of the three-dimensional content item may be adjusted based on the type of user interaction with the three-dimensional content item. The types of user actions that the user can engage depends on the type of electronic device 102, 104, 106 being used. In one example, the user may engage in a pinch-type user interaction with respect to the three-dimensional content. The display size of the three-dimensional content item is modified (e.g., zoom in and/or zoom out features) with respect to the user interface of the electronic device in response to the pinch-type user interaction. In another example, the user interaction is a tilt-type interaction about an axis. The three-dimensional content item is adjusted to tilt about the axis in response to the tilt-type user action.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

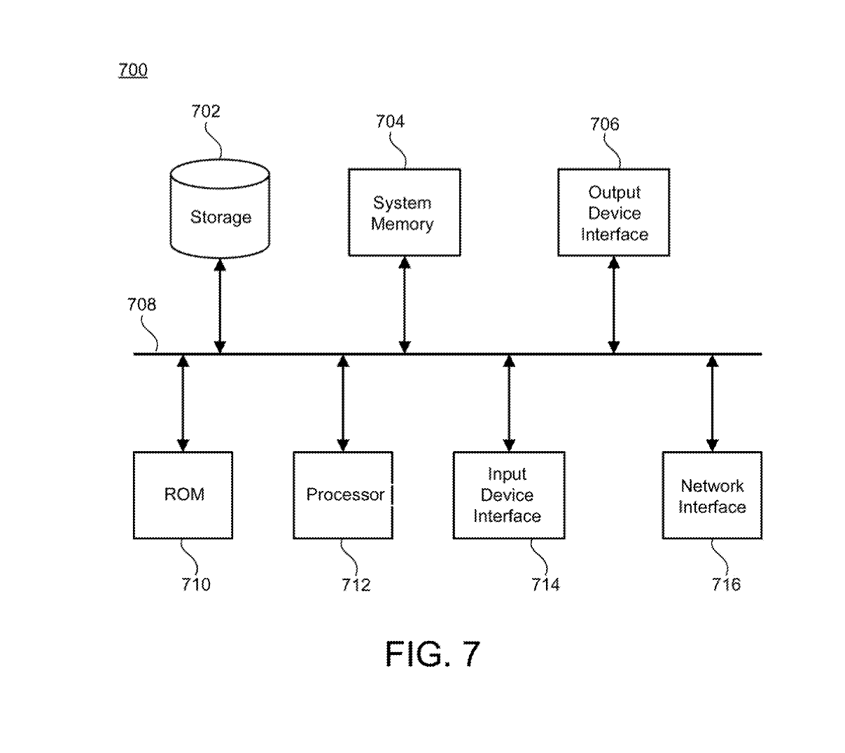

FIG. 7 conceptually illustrates an electronic system with which some implementations of the subject technology are implemented. Electronic system 700 can be a laptop computer, a desktop computer, smartphone, PDA, a tablet computer or any other sort of device 102, 104, and 106. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

In addition, example aspects of the subject technology are related to a system for providing content associated with a point of interest. The system may include one or more processors and a machine-readable medium comprising instructions stored therein, which when executed by the one or more processors, cause the one or more processors to perform operations. The operations may include identifying a number of points of interest located in a geographical area associated with a mapping interface, receiving an indication of a user selection of a point of interest from among the number of points of interest located in the geographical area, retrieving content associated with the selected point of interest, and providing for display of the content associated with the selected point of interest.

Further example aspects are related to a method for providing a user with content associated with a point of interest. The method may include identifying a number of points of interest located in a geographical area associated with a mapping interface, receiving an indication of a user selection of a point of interest from among the number of points of interest located in the geographical area, generating content associated with the selected point of interest, and providing for display of the content associated with the selected point of interest.

Other example aspects relate to a non-transitory machine-readable medium that includes instructions stored therein, which when executed by a device, cause the device to perform operations for providing a user with content associated with a point of interest. The operations may include identifying a number of points of interest located in a geographical area associated with a mapping interface, receiving an indication of a user selection of a point of interest from among the number of points of interest located in the geographical area, retrieving content associated with the selected point of interest, and providing for display of the content associated with the selected point of interest.

These and other aspects can include the following features. The retrieving of the content, in some aspects, may be based on user information or device information. The operations or steps, in some aspects, may also include generating the content associated with the selected point of interest. In one aspect, the generating of the content may be performed subsequent to the receiving of the selection of the point of interest. In another aspect, the identifying of the number of points of interest located in the geographical area may be performed subsequent to the generating of the content.

According to some aspects, the content may include one or more content items. According to one aspect, the content items may include pictures, video, text, or audio. Furthermore, the content may include a fly-through view.

According to one aspect, generating the content may include identifying content items associated with the selected point of interest and selecting one or more of the identified content items to be included in the content. According to one aspect the one or more of the identified content items may be selected based on a number of views or a view associated with the content items.

According to one aspect of the subject technology, providing the user with the content associated with the selected point of interest includes transmitting the content to a client device associated with the user.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's electronic device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to an electronic device (e.g., for purposes of displaying data to and receiving user input from a user interacting with the electronic device). Data generated at the electronic device (e.g., a result of the user interaction) can be received from the electronic device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g. her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for providing content for a point of interest, the method comprising:
providing one or more two-dimensional content items for display on a user interface of an electronic device, wherein each of the one or more two-dimensional content items represents a corresponding point of interest;
receiving a user selection of one of the one or more two-dimensional content items; and
providing, in response to receiving the user selection of the one of the one or more two-dimensional content items, a three-dimensional content item for display, wherein the three-dimensional content item corresponds to a point of interest that is represented by the selected two-dimensional content item.

2. The computer-implemented method of claim 1, further comprising:
receiving a user-designated geographical location,
wherein the one or more two-dimensional content items represent one or more corresponding points of interest that are located at or near the received user-designated geographical location.

3. The computer-implemented method of claim 1, wherein the one or more two-dimensional content items represent one or more corresponding points of interest that are located at or near a prior user-designated geographical location.

4. The computer-implemented method of claim 1, further comprising:
receiving a user interaction with respect to the three-dimensional content item; and
adjusting display of the three-dimensional content item based on a type of the user interaction.

5. The computer-implemented method of claim 4, wherein the user interaction is a pinch-type user interaction, and
wherein the three-dimensional content item is adjusted to zoom in or zoom out in response to the pinch-type user interaction.

6. The computer-implemented method of claim 4, wherein the user interaction is a tilt-type interaction about an axis, and
wherein the three-dimensional content item is adjusted to tilt about the axis in response to the tilt-type user action.

7. The computer implemented method of claim 1, wherein each of the one or more two-dimensional content items is pictorial preview of a corresponding point of interest.

8. The computer implemented method of claim 7, wherein the provided three-dimensional content item is a fly-through sequence from a first location on a three-dimensional interactive map to the point of interest that is represented by the selected two-dimensional pictorial preview.

9. The computer-implemented method of claim 1, wherein providing the one or more two-dimensional content items further comprises automatically selecting the one or more two-dimensional content items based on a type of the electronic device.

10. The computer implemented method of claim 1, further comprising:
providing a three-dimensional representation of the Earth, and
wherein the one or more two-dimensional content items represent one or more preselected points of interest that are of global interest for the Earth.

11. A system for providing content for a point of interest, the system comprising:
one or more processors, and
a machine-readable medium comprising instructions stored therein, which when executed by the processors, cause the processors to perform operations comprising:
providing one or more two-dimensional content items for display on a user interface of an electronic device, wherein each of the one or more two-dimensional content items represents a corresponding point of interest;
receiving a user selection of one of the one or more two-dimensional content items;
providing, in response to receiving the user selection of the one of the one or more two-dimensional content items, a three-dimensional content item for display, wherein the three-dimensional content item corresponds to a point of interest that is represented by the selected two-dimensional content item;
receiving a user interaction with respect to the three-dimensional content item; and
adjusting display of the three-dimensional content item based on a type of the user interaction.

12. The system of claim 11, further comprising:
receiving a user-designated geographical location,
wherein the one or more two-dimensional content items represent one or more corresponding points of interest that are located at or near the received user-designated geographical location.

13. The system of claim 1, wherein the one or more two-dimensional content items represent one or more corresponding points of interest that are located at or near a prior user-designated geographical location.

14. The system of claim 11, wherein the user interaction is a pinch-type user interaction, and
wherein the three-dimensional content item is adjusted to zoom in or zoom out in response to the pinch-type user interaction.

15. The system of claim 11, wherein the user interaction is a tilt-type interaction about an axis, and
wherein the three-dimensional content item is adjusted to tilt about the axis in response to the tilt-type user action.

16. The system of claim 11, wherein each of the one or more two-dimensional content items is pictorial preview of a corresponding point of interest.

17. The system of claim 11, wherein the provided three-dimensional content item is a fly-through sequence from a first location on a three-dimensional interactive map to the point of interest that is represented by the selected two-dimensional pictorial preview.

18. A machine-readable medium comprising instructions stored therein, which when executed by a processor, cause the processor to perform operations comprising:
receiving a user-designated geographical location; and
providing one or more two-dimensional content items for display on a user interface of an electronic device, wherein each of the one or more two-dimensional content items represents a corresponding point of interest that is located at or near the received user-designated geographical location;
receiving a user selection of one of the one or more two-dimensional content items;
providing, in response to receiving the user selection of the one of the one or more two-dimensional content items, a three-dimensional content item for display, wherein the three-dimensional content item corresponds to a point of interest that is represented by the selected two-dimensional content item;
receiving a user interaction with respect to the three-dimensional content item; and
adjusting display of the three-dimensional content item based on a type of the user interaction.

19. An electronic device comprising:
a processor;
memory and a display;
the processor configured to provide a user interface depicting a three-dimensional representation of the Earth from a view of a virtual camera,
wherein the processor is configured to change the view of the virtual camera in response to input directed to a first area of the user interface according to a three-dimensional heuristic, and
wherein the processor is configured to provide a graphical selection element in a second area of the user interface and respond to input directed to the second area of the user interface according to a two-dimensional heuristic.

20. The electronic device of claim 19, wherein the three-dimensional heuristic maps one or more input gestures to at least one of the following commands: pan the virtual camera, zoom the virtual camera, rotate the virtual camera, tilt the virtual camera, or rotate the three-dimensional representation of the Earth.

21. The electronic device of claim 19, wherein the two-dimensional heuristic maps one or more input gestures to at least one of the following commands: carry out an action associated with the graphical selection element, display a different graphical selection element.

22. The electronic device of claim 21, wherein the input gesture is a swipe gesture and the two-dimensional heuristic maps the swipe gesture to the command to display a different graphical selection element.

23. The electronic device of claim 19, wherein the graphical selection element comprises a filmstrip having a plurality of individual frames, each frame corresponding to an item of content associated with geographic areas shown in the view of the virtual camera.

24. The electronic device of claim 23, wherein at least one graphical selection element corresponds to a tour of a geographic area and the processor, in response to selection of the tour, carries out an action to provide a tour and provides the tour by moving the camera within the three-dimensional representation of the Earth.

25. The electronic device of claim 19, wherein the first area of the user interface depicts the three-dimensional representation of the Earth and the second area of the user interface comprises an overlay within the first area of the user interface.
